(19) United States
(12) Patent Application Publication
(10) Pub. No.: US 2017/0215234 A1
(43) Pub. Date: Jul. 27, 2017

(54) METHODS OF MANUFACTURING GASKETS FROM PTFE SHEETS

(71) Applicant: Garlock Sealing Technologies, LLC, Palmyra, NY (US)

(72) Inventors: Tom Maslyn, Palmyra, NY (US); Joseph Young, Palmyra, NY (US); Wayne Evans, Palmyra, NY (US)

(21) Appl. No.: 15/415,189

(22) Filed: Jan. 25, 2017

Related U.S. Application Data
(60) Provisional application No. 62/287,369, filed on Jan. 26, 2016.

(51) Int. Cl. H05B 3/06; F16J 15/10

(52) U.S. Cl. CPC H05B 3/06; F16J 15/108; F16J 15/102

(57) ABSTRACT

A method of forming gaskets from a sheet of material is disclosed. The method includes cutting one or more elongated strips from the sheet of material, such as by using a spiral cut. The elongated strip is then cut into segments, with the segments being placed in a gasket mold. The segments are placed in the gasket mold so that the ends overlap. Heat and/or pressure are applied to mold together the ends. The resulting gasket has only a single joint that is molded together rather than welded. Additionally, the manner in which the sheet of material is cut helps to maximize the amount of the sheet of material that is used to make gaskets.

### CROSS-REFERENCE TO RELATED APPLICATIONS

This application claims priority to U.S. Provisional Patent Application No. 62/287,369, filed Jan. 26, 2016, which application is incorporated herein by reference as if set out in full.

### BACKGROUND

Efficiently using material during the manufacture of large gaskets (e.g., 20 inch outer diameter (OD) or larger) has long been a difficult objective to achieve. For example, only six complete gaskets having a 20 inch OD can be obtained from a 60 inch by 60 inch sheet of material, with the remaining material either being waste or having to be repurposed for other, smaller gaskets.

Some prior methods have attempted to make better use of sheet material by cutting numerous arcs from a single sheet of material, but this method requires that the various arcs be welded together to form a complete gasket. In some embodiments, each gasket needs 3 to 4 welds to form a complete gasket. Each weld is a weak point in the structure of the gasket and can therefore cause performance issues. Additionally, the welding together of numerous arcs increases labor costs associated with manufacturing gaskets.

In some version of the previously described method, “fingers” are cut into the ends of each arc such that when two arcs are brought together, the fingers interlock. Temperature and load are then applied to encourage the joint edges to bond together. FIG. 1 shows gaskets 100 formed with interlocking fingers 110 in this manner. Disadvantages associated with this method can include reduced flexibility and tensile strength, a need to machine fixtures for new sizes, and less than desirable material utilization.

In another version of the previously described method, the ends of arcs 200 are cut to include bevels 210 as shown in FIG. 2. When two arcs 200 are brought together, the ends overlap slightly due to the bevel cuts 210. Heat and/or pressure are applied, such as via rams 220, in order to bond the two arc segments 200 together. Disadvantages of this method can include slower throughput and less consistent bonding.

### SUMMARY

This summary is provided to introduce a selection of concepts in a simplified form that are further described below in the Detailed Description. This Summary, and the foregoing Backgrounds, is not intended to identify key aspects or essential aspects of the claimed subject matter. Moreover, this Summary is not intended for use as an aid in determining the scope of the claimed subject matter.

Described herein are methods of manufacturing gaskets from sheets of material in a manner that reduces material waste while also creating better performing gaskets. In some embodiments, the method includes providing a sheet of gasket material, cutting one or more continuous and elongated strips of material from the sheet of gasket material, cutting a segment from this elongated strip of material, placing the segment in a gasket mold such that the ends slightly overlap, and then applying heat and/or pressure in order to bond the ends together.

Gasket seals manufactured by the methods described herein are also described.

These and other aspects of the methods and gaskets described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in this Summary.

### BRIEF DESCRIPTION OF THE DRAWINGS

Non-limiting and non-exhaustive embodiments of the disclosed methods and gaskets, including the preferred embodiments, are described with reference to the following figures, wherein like reference numerals refer to like parts throughout the various views unless otherwise specified.

FIG. 1 is an illustration of a prior art method for joining together one of several arcs to form a complete gasket.

FIG. 2 is an illustration of a prior art method for joining together one of several arcs to form a complete gasket.

FIG. 3 is a flow chart illustrating methods of manufacturing a gasket from a sheet of material according to various embodiments described herein.

FIG. 4 is an illustration of a continuous strip of sheet material cut according to various embodiments described herein.

FIG. 5 is an illustration of a continuous strip of sheet material cut according to various embodiments described herein.

FIG. 6 is an illustration of a mold having a strip of sheet material disposed in the mold groove according to various embodiments described herein

FIG. 7 is an illustration of a mold suitable for use in various embodiments described herein.

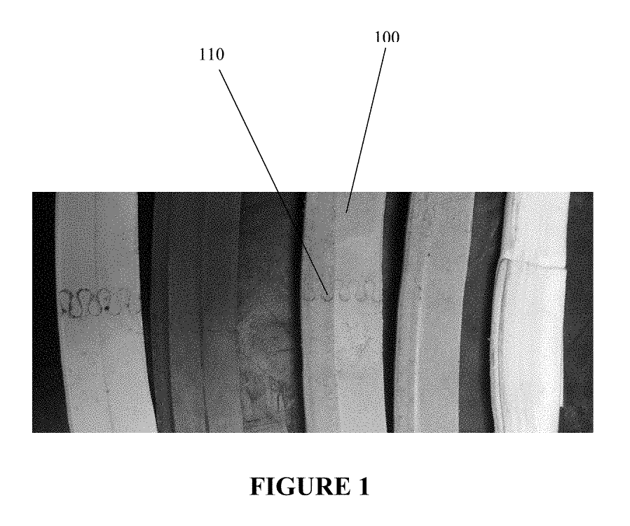

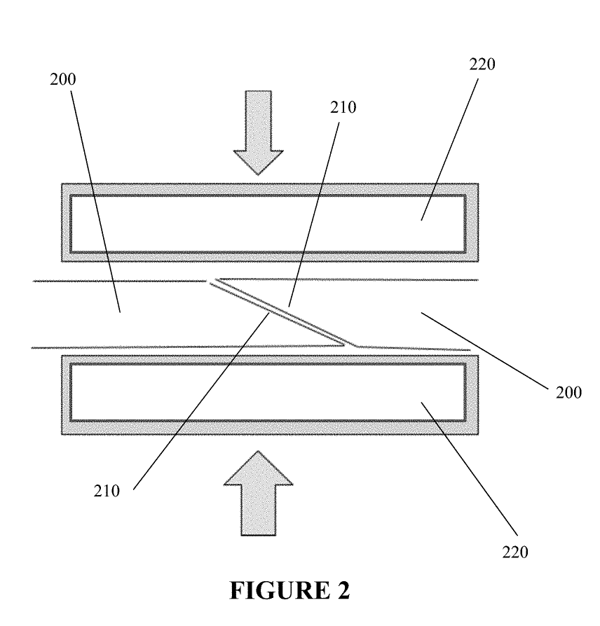

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, the embodiments may be implemented in many different forms and should not be construed as being limited to the embodiments set forth herein. The following detailed description is, therefore, not to be taken in a limiting sense.

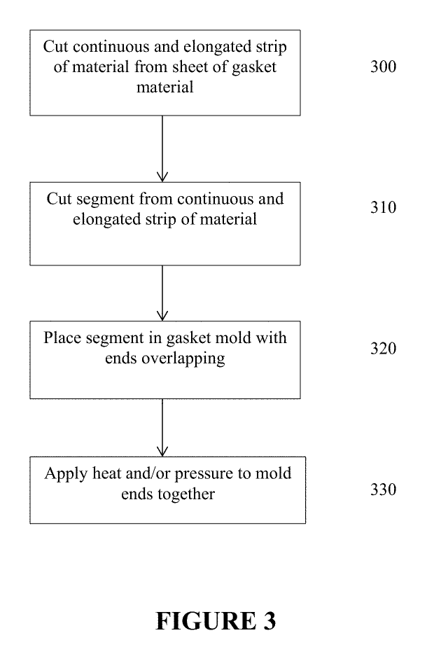

With reference to FIG. 3, embodiments of the method described herein generally include a step 300 of cutting at least one continuous and elongated strip of material from the sheet of gasket material, a step 310 of cutting a segment from this elongated strip of material, a step 320 of placing the segment in a gasket mold such that the ends slightly overlap, and a step 330 of applying heat and/or pressure in order to mold the ends together.

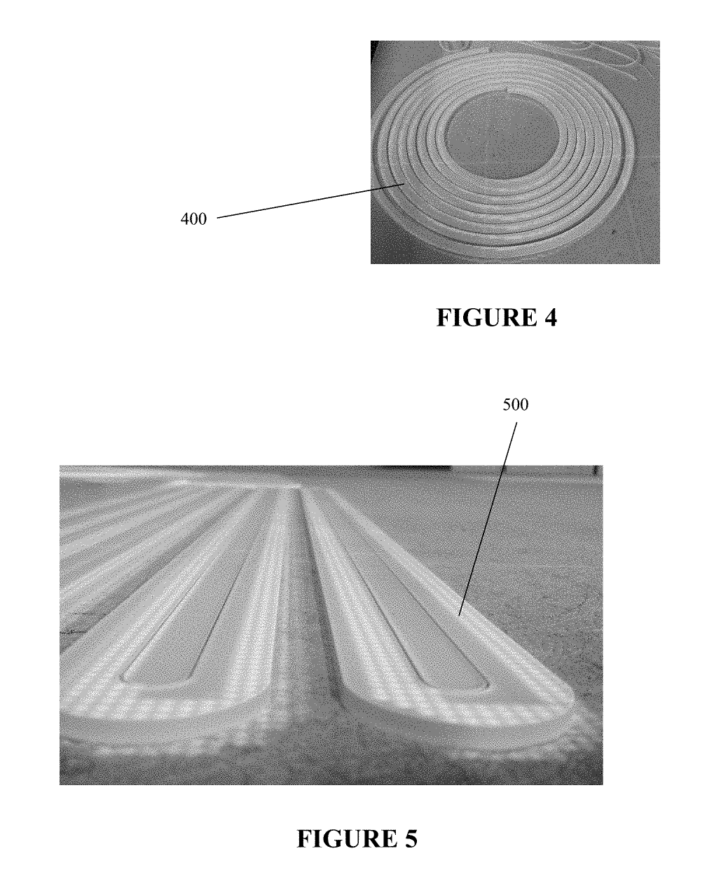

Regarding step 300, the method described herein generally begins with cutting elongated strips from a sheet of material. In some embodiments, the strip is a continuous strip of material cut from sheet material, such as by using a spiral cut. FIG. 4 illustrates a single continuous strip of material 400 cut from a sheet of material using a spiral cut. Other types of cuts can also be used provided that elongated and continuous strips of the sheet material are provided in order to subsequently manufacture large diameter gaskets from the strips of material. For example and as shown in FIG. 5, oval shaped cuts can be used to create elongated strips 500 of the sheet material.

The length of the continuous strip cut in step 300 is not limited, though in some embodiments it is preferred that as much of the sheet of the material be used when cutting the strip of material to thereby create the longest strip of material possible and avoid material waste. The width of the strip is preferably the desired width for the gasket formed from the strip (i.e., the difference between the gaskets inner and outer diameters).

The material of the sheet from which the elongated and continuous strip is cut in step 300 is generally not limited provided the sheet material is a suitable material for gaskets. Exemplary sheet materials include, but are not limited to, ceramics, metals, fiberglass, and polymers. In some embodiments, the sheet material is preferably PTFE, and more specifically unsintered, calendared PTFE material (though sintered PTFE can also be used).

While the sheet material used in step 300 is typically provided in large rectangles, the sheet material suitable for use with the methods described herein can be any shape provided that elongated and continuous strips of material can be cut from the sheet. The lack of limitation on the shape of the sheet materials means that odd shaped sheet material can be used, including, potentially, waste material from other processes.

In step 300, any manner of cutting the strips of material from the sheet of material can be used. The strips can be cut manually or using general or specialized machinery. In some embodiments, machinery capable of making spiral cuts is preferred. In some embodiments, the machinery is capable of carryout customizable cuts so that different cuts can be made on different sized and shaped sheets of material.

Once an extended strip of material is prepared, a step 310 of cutting the elongated strip of material into two or more segments is carried out. Any suitable manner of cutting the strip into segments can be used. The length of the segments is preferably slightly larger than the circumference of the gasket to be manufactured such that the ends of the segments of material slightly overlap once the segment is laid out in the shape of a circle.

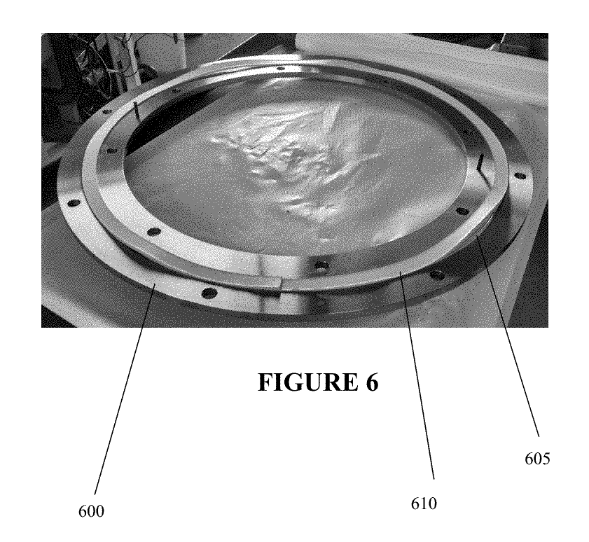

In step 320, segments can subsequently be placed in a mold groove having the shape and size of the desired gasket. The segment should be placed in the mold groove such that the entire circumference of the mold groove is filled with the segment and there is a slight overlap of the ends of segment. The exact amount of overlap is generally not restricted provided that enough overlap is provided to allow for the ends to be molded together. FIG. 6 provides an illustration of a mold 600 where the mold groove 605 is filled with the segment 610 in the manner described above. As shown towards the bottom of FIG. 6, the ends of the segment 610 slightly overlap.

Any suitable mold can be used for carrying out step 320. As noted above, the mold generally includes a groove into which the strip material is laid, and the shape of the groove provides the ultimate shape of the gasket produced.

In some embodiments, the groove may be shaped such that the resulting gasket includes one or more concentric rings protruding outwardly from either or both faces of the main gasket body. These concentric rings reduce the contact area of the gasket with a flange. The resulting flange load created by tightening flange bolts is thus distributed over a relatively small surface area resulting in relatively high stress in the regions of the rings. The rings thus enable the gasket to effect a seal at reduced bolt loading. The mold groove can be configured to include any other type of stress concentrators, markings, brandings, etc.

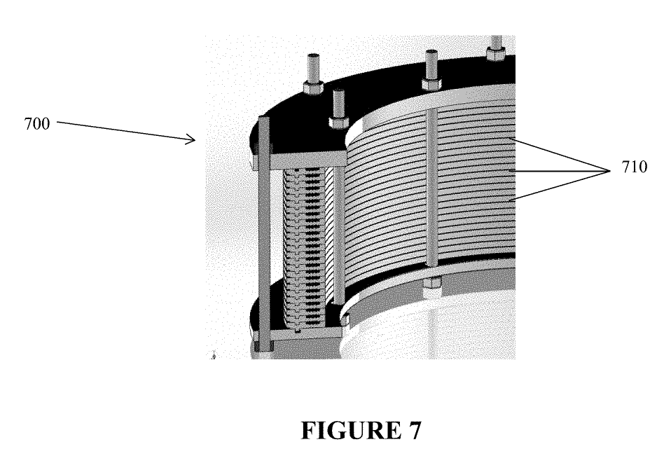

FIG. 7 shows a contemplated mold system 700 in which multiple gaskets can be formed at once. A strip of sheet material is placed in the groove of each mold 710 and then the molds 710 are stacked vertically. Once stacked, heat and/or pressure are applied to the stack of molds to thereby form a gasket in each of the molds in one pressure and/or heating step.

In some embodiments, the segment can be subjected to a preheating step prior to being placed in the mold, or after being placed in the mold but before application of the final heat and/or pressure step. The preheating step may be carried out in order to heat the segment and bring it closer to its gel point prior to carrying out the molding step. In some embodiments, the preheating step is carried out in a hatch oven.

Once the segment is appropriately laid into the mold groove (i.e., with the appropriate amount of overlap), the mold can be subjected to heat and/or pressure in step 330 in order to mold together the overlapping ends of the segment. Any suitable pressure and/or heat can be applied provided that the pressure and/or heat applied results in the molding together of the ends of the segment and the formation of any additional features, if desired. In some embodiments, the heat and/or pressure applied will be based upon the material of the segment. In some embodiments where preheating is used, the molding step involves the application of pressure and a cooling temperature.

In some embodiments, the placing step 320 and the molding step 330 are carried out in a manner that produces a gasket having a core material embedded within the gasket. Producing a gasket having an embedded core layer can generally entail placing a first segment of material in a mold as described previously with respect to step 320, followed by placing a core material on top of the segment placed in the mold, and finally playing another segment of material over the core material in a manner similar or identical to the placing step 320 described previously. The molding step 330 then takes place as described previously, with the result being that the bottom and top segment of material mold together and embed the core material therein. In such embodiments, the mold groove, segments of material and core material are also sized and dimensioned so that all three layers of material can fit within the mold groove. The material of the core layer is generally not limited, and my include, for example, metal or fiber.

Once the molding step 330 is complete, the resulting gasket structure can be removed from the groove of the mold and any final cutting or polishing can take place. The resulting material is generally a gasket having only a single joint and therefore reduced heat affected zones. Various benefits of this gasket material and the process of making the gasket material are described in greater detail below.

As discussed, embodiments of the method described herein, including the embodiment illustrated in FIG. 3, generally use a pre-formed sheet of material that is cut into an elongated and continuous strip, such as described in step 300. In alternate embodiments, the cutting step 300 can be replaced with a paste extrusion process. In such an embodiment, a slurry or paste of material is extruded through a die to form the elongated and continuous strip of material formed in step 300 as described previously. Once formed, the strip of material can be cut into segments such as described in step 310, and the method generally proceeds as described previously. An optional calendaring step can also be carried out on the strip of material formed by the past extrusion process prior to cutting the strip of material into segments.

The paste material used in the paste extrusion process can generally be similar or identical to the materials described previously, with the exception that the material is provided in a paste form so as to be suitable for the extrusion process. The machinery used for the paste extrusion process is generally not limited, but will typically include a die through which the paste is extruded and a ram to push the material through the die. The shape of the die can be selected so that the continuous and elongated strip of material has the desired cross sectional dimensions for the molding step. The length of the strip of material produced by the extrusion process is generally not limited, but in some embodiments, the length is at least as long as the circumference of the gasket that is to be formed from the extruded strip of material. The extruded strip of material produced by the paste extrusion step can be treated prior to performing additional steps, such as steps to harden or solidify the extruded strip of material.

As discussed previously, the material suitable for use in this process is generally not limited. In some embodiments, the material is virgin or filled PTFE. The material can also be unsintered or sintered PTFE. The material can also be calendared or un-calendared. Calendaring the PTFE material allows for higher filler content and fibrillates the PTFE. A higher filler content allows for improved material properties.

The gasket formed from embodiments of the method described herein can generally have a ring-like shape, with an inner diameter, and outer diameter, and a thickness. The dimensions of the gasket are generally not limited and can be based on the specific application for which the gasket is needed. The material of the gasket is as described previously with respect to the sheet of material used in order to carry out the method. In some embodiments, the gasket is made from filled, calendared PTFE, though other materials, including other types of PTFE can also be used.

The gaskets described herein generally have a single seam, as opposed to gasket formed from several arcs of material that have three, four, or more seams. The seam is a molded seam rather than a welded seam.

While embodiments of the method described herein have been described primarily with respect to forming a gasket, other articles can also be formed using the general steps described herein. For example, cylinders can be manufactured using the methods described herein, with such cylinders being used to subsequently form rotors or stators of a bearing isolator. Non-round parts can also be formed.

The embodiments described herein also discuss primarily the formation of articles having a single seam. Articles having more complex geometries, and therefore requiring more than one seam, can also be produced using embodiments of the method described herein. In one example, a rectangular-shaped article may require multiple seams.

### Example

A 60 inch by 60 inch sheet of PTFE is provided for manufacturing gaskets having a 20 inch inner diameter (ID) and a 21.5 inch outer diameter (OD).

Complete gaskets having the desired dimensions are formed from a first sheet of PTFE, and a total of 6 gaskets are formed using the available space of the PTFE sheet.

The process described herein is then used to spiral cut the PTFE sheet. Using a single bond at a single joint, 40 gaskets are formed using the material of the single 60 inch by 60 inch PTFE sheet.

Accordingly, the method described herein provides 10 times more gaskets of the desired size per PTFE sheet than when complete gaskets are formed from the PTFE sheet. Additionally, because only a single bond point is required for the gaskets formed using spiral cutting, the performance of the gaskets is comparable to the complete gaskets.

The benefits of the methods described herein can include one or more of the following:

1) reducing the number of joints in a gasket material, which reduces manufacturing steps and labor costs, and improves seal performance by minimizing potential weak spots in the gasket.

2) the gaskets can be considered molded gaskets rather than welded gaskets, which improves their perception in the market. Welded parts are associated with heat affected zones, which negatively affect the material properties around where thermal load is applied. The gasket described herein are more akin to molded parts due to their minimization of joints and associated heat affected zones.

3) molded profiles are useful in the sealing world, such as for centering, increasing gasket stress, etc.

4) methods described herein allow for a useful product to be formed from odd shapes of sheet material.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method of manufacturing a gasket from a sheet of material, the method comprising:
cutting a sheet of material in a manner that creates a continuous and elongated length of the material;
cutting a segment from the continuous and elongated length of the material, the segment having a length longer than the circumference of the gasket to be formed;
placing the segment in a recess of a gasket mold such that the opposite ends of the segment overlap; and
applying heat, pressure, or both to the mold to thereby cause the ends of the segment to mold together.

2. The method of manufacturing a gasket from a sheet of material as claimed in claim 1, wherein cutting the sheet of material comprises spiral cutting the sheet of material.

3. The method of manufacturing a gasket from a sheet of material as claimed in claim 1, wherein cutting the sheet of material comprises cutting a series of elongated ovals from the sheet of material.

4. The method of manufacturing a gasket from a sheet of material as claimed in claim 1, wherein cutting the sheet of material comprises spiral cutting a sheet of PTFE.

5. The method of manufacturing a gasket from a sheet of material as claimed in claim 1, wherein cutting the sheet of material comprises cutting a sheet of unsintered, calendared PTFE.

6. The method of manufacturing a gasket from a sheet of material as claimed in claim 1, wherein cutting the sheet of material comprises cutting a sheet of sintered PTFE.

7. The method of manufacturing a gasket from a sheet of material as claimed in claim 1, wherein placing the segment in a recess of a gasket mold comprises placing the segment in a recess configured to form one or more concentric rings protruding outwardly from either or both faces of the gasket.

8. The method of manufacturing a gasket from a sheet of material as claimed in claim 1, wherein placing the segment in a recess of a gasket mold comprises placing a segment the recess of each of a plurality of gasket molds; and vertically stacking the plurality of gasket molds; prior to applying heat, pressure or both molds.

9. The method of manufacturing a gasket from a sheet of material as claimed in claim 1, further comprising:
preheating the segment prior placing the segment in the recess of the gasket mold.

10. The method of manufacturing a gasket from a sheet of material as claimed in claim 9, wherein preheating the segment prior placing the segment in the recess of the gasket mold comprises preheating the segment to a temperature below the gel temperature of the material.

11. The method of manufacturing a gasket from a sheet of material as claimed in claim 1, wherein the method is free of welding.

12. The method of manufacturing a gasket from a sheet of material as claimed in claim 1, wherein the method produces a gasket having a single molded joint.

13. A molded, single seam gasket, comprising:
a ring-shaped gasket having a single molded seam where the ends of a strip of material are overlapped and molded together during the manufacturing process;
wherein the material of the ring-shaped gasket is PTFE.

14. The molded, single-seam gasket of claim 13, wherein the PTFE is filled PTFE.

15. The molded, single-seam gasket of claim 14, wherein the filled PTFE is sintered, calendared filled PTFE.

16. A molded, single seam gasket manufactured by a process comprising:
cutting a sheet of material in a manner that creates a continuous and elongated length of the material;
cutting a segment from the continuous and elongated length of the material, the segment having a length longer than the circumference of the gasket to be formed;
placing the segment in a recess of a gasket mold such that the opposite ends of the segment overlap; and
applying heat, pressure, or both to the mold to thereby cause the ends of the segment to mold together.

17. The molded, single seam gasket of claim 16, wherein the material of the gasket is PTFE.

18. The molded, single seam gasket of claim 17, wherein the PTFE is filled PTFE.

19. The molded, single seam gasket of claim 18, wherein the filled PTFE is sintered, calendared filled PTFE.
